(19) United States
(12) Patent Application Publication
(10) Pub. No.: US 2024/0091620 A1
(43) Pub. Date: Mar. 21, 2024

(54) PROCESSING DEVICE

(71) Applicant: Murata Manufacturing Co., Ltd., Kyoto (JP)

(72) Inventors: Takehiko IIZUKA, Kyoto (JP); Tomoshige FURUHI, Kyoto (JP); Koji KAWANO, Kyoto (JP); Jun MAKINO, Kyoto (JP)

(21) Appl. No.: 18/522,834

(22) Filed: Nov. 29, 2023

Related U.S. Application Data
(63) Continuation of application No. PCT/JP2022/018560, filed on Apr. 22, 2022.

(30) Foreign Application Priority Data
May 31, 2021 (JP) 2021-090926

(51) Int. Cl. A63B 69/36

(52) U.S. Cl. CPC A63B 69/3617; A63B 69/3614

(57) ABSTRACT

A processing device includes an operation circuit that determines based on a first signal a swing start time, the first signal being acquired from a sensor that is attached to a striking member for striking a to-be-struck object by being swung and that detects deformation of the striking member when the striking member is swung. An absolute value of a difference between a reference value and a value of the first signal is defined as a first difference value. The operation circuit executes a first determination step in which an impact time is determined based on one or more times at which the first difference value becomes greater than or equal to a first determination value.

### CROSS REFERENCE TO RELATED APPLICATION

This is a continuation of International Application No. PCT/JP2022/018560 filed on Apr. 22, 2022 which claims priority from Japanese Patent Application No. 2021-090926 filed on May 31, 2021. The contents of these applications are incorporated herein by reference in their entireties.

### BACKGROUND OF THE DISCLOSURE

### Field of the Disclosure

The present disclosure relates to a processing device that detects the moment at which a user starts swinging a striking member such as a golf club.

### Description of the Related Art

Hitherto, a swing analyzer described in Patent Document 1 has been known as a disclosure for analyzing the swing of a golf club by a user. In the swing analyzer described in Patent Document 1, a sensor is attached to the shaft of a golf club. The swing analyzer analyzes the swing of a user on the basis of a signal acquired from the sensor.
Patent Document 1: Japanese Unexamined Patent Application Publication No. 2018-175496

### BRIEF SUMMARY OF THE DISCLOSURE

Regarding the swing analyzer described in Patent Document 1, it is desired to identify with high accuracy the moment at which the user starts swinging a striking member such as a golf club.

A possible benefit of the present disclosure is to provide a processing device that identifies with high accuracy the moment at which the user starts swinging a striking member.

As a method for identifying with high accuracy the moment at which a user starts swinging a striking member, the inventor of the present application examined a method for identifying the time at which an acquired signal exceeds a determination value to be a swing start time. In this case, the determination value is set on the basis of the value of a signal generated by the swing. A processing device detects, as a swing start time, the time at which the value of a signal obtained from a sensor exceeds the determination value.

However, the inventor of the present application realized that an impact may be applied to the striking member by a movement other than the user's swing. A movement other than the user's swing is, for example, a movement that accidentally knocks down the striking member. In this case, the inventor of the present application realized that a force equivalent to the force generated by swinging may be applied to the striking member. As a result, the inventor of the present application realized that the processing device may erroneously detect the movement other than swinging as the start of swinging.

Thus, the inventor of the present application considered the use state of the striking member. As a result of consideration, the inventor of the present application realized that the moment at which the strongest impact is applied to the striking member is the moment of impact at which the striking member and a to-be-struck object collide. That is, the inventor of the present application realized that no impact greater than the impact applied at the moment of impact is applied to the striking member. As a result, the inventor of the present application realized that the processing device is less likely to erroneously detect the moment of impact in a case where a first determination value is set on the basis of a signal value obtained at the moment of impact.

Thus, the inventor of the present application believed that a processing device that is less likely to perform erroneous detection can be provided using the following method. In a case where an impact time is detected, the processing device determines that the user has made a swing movement. The processing device identifies a swing start time from among times at which a signal was acquired before the impact time.

On the basis of the examinations described above, the inventor of the present application again examined a method for detecting with high accuracy the moment at which the user starts swinging a striking member such as a golf club. As a result, the inventor of the present application came up with the following disclosures.

A processing device according to an embodiment of the present disclosure includes an operation circuit that determines based on a first signal a swing start time, the first signal being acquired from a sensor that is attached to a striking member for striking a to-be-struck object by being swung and that detects deformation of the striking member when the striking member is swung, and an absolute value of a difference between a reference value and a value of the first signal is defined as a first difference value, and the operation circuit executes a first determination step in which an impact time is determined based on one or more times at which the first difference value becomes greater than or equal to a first determination value, a first identification step in which, in the first signal acquired in a time period before the impact time, a most recent period that is closest to the impact time is identified from among one or more periods where the first difference value is less than a second determination value for a reference time period, and a second identification step in which a swing start time is identified based on the most recent period.

A processing device according to an embodiment of the present disclosure includes an operation circuit that determines based on a first signal a swing start time, the first signal being acquired from a sensor that is attached to a striking member for striking a to-be-struck object by being swung and that detects deformation of the striking member when the striking member is swung, and a time at which a value of the first signal changes from above a reference value to below the reference value and a time at which the value of the first signal changes from below the reference value to above the reference value are each defined as a cross time, an absolute value of a difference between the reference value and the value of the first signal is defined as a first difference value, and the operation circuit executes a first determination step in which an impact time is determined based on one or more times at which the first difference value becomes greater than or equal to a first determination value, a first identification step in which one or more of the cross time are identified in the first signal acquired in a time period before the impact time, and a second identification step in which a swing start time is identified based on the cross time that is an n-th closest to the impact time from among the one or more cross times, n being a reference number.

In the present specification, axes and members extending in the front-back direction do not necessarily indicate only axes and members parallel to the front-back direction. An axis or member extending in the front-back direction is an axis or member inclined in the range of ±45° to the front-back direction. Similarly, an axis or member extending in the up-down direction is an axis or member inclined in the range of ±45° to the up-down direction. An axis or member extending in the left-right direction is an axis or member inclined in the range of ±45° to the left-right direction.

In the following, a first member and a second member are structures that a sensor device is equipped with. In the present specification, the first member being arranged on or above the second member refers to the following state. At least part of the first member is located directly on or above the second member. Thus, when viewed in the up-down direction, the first member and the second member overlap each other. This definition applies to directions other than the up-down direction.

In the present specification, the first member being arranged on or above the second member includes a case where at least part of the first member is located directly on or above the second member and a case where the first member is not located directly on or above the second member and is located diagonally on or above the second member. In this case, the first member may not overlap the second member when viewed in the up-down direction. Diagonally on or above means, for example, upper left and upper right. This definition applies to the directions other than the up-down direction.

In this specification, unless otherwise specified, individual parts of the first member are each defined as follows. The front part of the first member means the front half of the first member. The rear part of the first member means the rear half of the first member. The left part of the first member means the left half of the first member. The right part of the first member means the right half of the first member. The upper part of the first member means the upper half of the first member. The lower part of the first member means the lower half of the first member. The front end of the first member means the forward end of the first member. The rear end of the first member means the rearward end of the first member. The left end of the first member means the leftward end of the first member. The right end of the first member means the rightward end of the first member. The upper end of the first member means the upward end of the first member. The lower end of the first member means the downward end of the first member. The front end portion of the first member means the front end of the first member and its vicinity. The rear end portion of the first member means the rear end of the first member and its vicinity. The left end portion of the first member means the left end of the first member and its vicinity. The right end portion of the first member means the right end of the first member and its vicinity. The upper end portion of the first member means the upper end of the first member and its vicinity. The lower end portion of the first member means the lower end of the first member and its vicinity.

A processing device according to the present disclosure can identify with high accuracy the moment at which a user starts swinging a striking member.

### BRIEF DESCRIPTION OF THE SEVERAL VIEWS OF THE DRAWINGS

FIG. 1 is a diagram illustrating an example of a striking member 1 to which a sensor 10, an analog-to-digital (AD) converter 20, and a processing device 30 are attached.

FIG. 2 is a block diagram of the sensor 10, the AD converter 20, and the processing device 30.

FIG. 3 includes a rear view and a left side view of the sensor 10.

FIG. 4 is a diagram illustrating an example of a first signal DSig1 outputted from the sensor 10 to the processing device 30.

FIG. 5 is a flowchart illustrating processing performed by the processing device 30.

FIG. 6 is a flowchart illustrating processing performed by a processing device 30a.

FIG. 7 is a diagram illustrating an example of a third identification step executed by an operation circuit 300a.

FIG. 8 is a flowchart illustrating processing performed by a processing device 30b.

FIG. 9 is a graph illustrating an example of a swing start time identified through processing performed by an operation circuit 300c.

FIG. 10 is a flowchart illustrating processing performed by a processing device 30c.

FIG. 11 is a diagram illustrating an example of communication between a processing device 30d and a second processing device 40.

FIG. 12 is a diagram illustrating an example of a deletion step executed by a processing device 30e.

### DETAILED DESCRIPTION OF THE DISCLOSURE

### First Embodiment

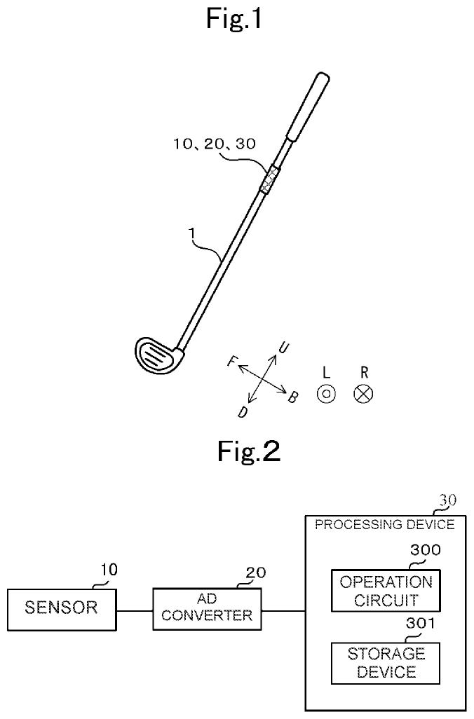

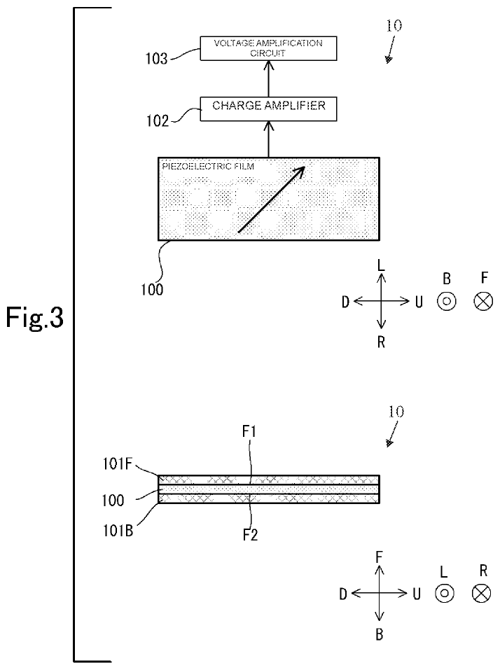

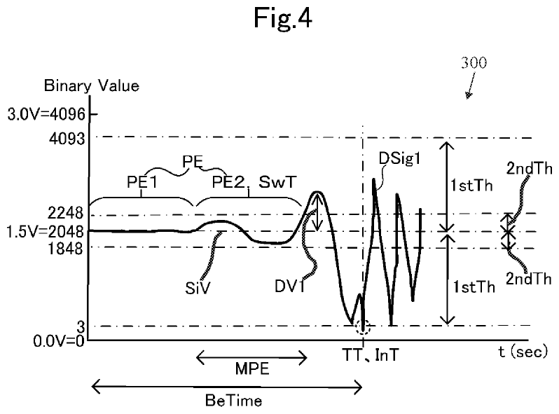

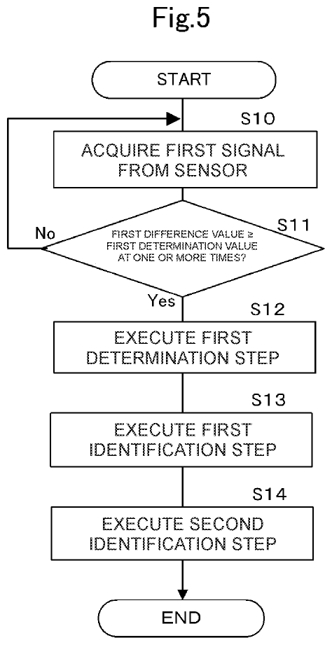

In the following, a processing device 30 according to a first embodiment will be described with reference to the drawings. FIG. 1 is a diagram illustrating an example of a striking member 1 to which a sensor 10, an analog-to-digital (AD) converter 20, and the processing device 30 are attached. FIG. 2 is a block diagram of the sensor 10, the AD converter 20, and the processing device 30. FIG. 3 includes a rear view and a left side view of the sensor 10. In the rear view illustrated in FIG. 3, the illustration of a first electrode 101F and a second electrode 101B is omitted. FIG. 4 is a diagram illustrating an example of a first signal DSig1 outputted from the sensor 10 to the processing device 30. In FIG. 4, the vertical axis represents signal output. In FIG. 4, the horizontal axis represents time. FIG. 5 is a flowchart illustrating processing performed by the processing device 30.

In the present embodiment, as illustrated in FIG. 1, the up-down, left-right, and front-back directions are defined. Specifically, the direction in which the shaft of the striking member 1 extends is defined as the up-down direction. The direction in which the face of the striking member 1 head faces is defined as the left direction. The direction orthogonal to the up-down and left-right directions is defined as the front-back direction. Note that the up-down, left-right, and front-back directions are defined for illustrative purposes. Thus, the up-down, left-right, and front-back directions when the striking member 1 is actually used may not match the up-down, left-right, and front-back directions illustrated in FIG. 1.

The striking member 1 is a member for striking a to-be-struck object. In the present embodiment, the striking member 1 is a golf club. Thus, in the present embodiment, the striking member 1 has a stick shape that extends in the up-down direction. A user strikes a to-be-struck object by swinging the striking member 1. During the user's swing, the striking member 1 deforms. Specifically, when the user swings the striking member 1, inertia and external forces cause the striking member 1 to deform. The striking member 1 deforms in the left-right direction, for example, during the swing.

The sensor 10, the AD converter 20, and the processing device 30 are attached to the striking member 1, which is for striking a to-be-struck object by being swung. As illustrated in FIG. 1, in the present embodiment, the sensor 10, the AD converter 20, and the processing device 30 are fixed to the striking member 1.

The sensor 10 is configured to detect deformation of the striking member 1 when the striking member 1 is swung. Specifically, the sensor 10 generates an electric charge corresponding to deformation of the striking member 1. The sensor 10 converts the electric charge into a first signal Sig1, which is a voltage signal. Thus, in the present embodiment, the value of the first signal Sig1 corresponds to the amount of deformation of the striking member 1 in the left-right direction. Moreover, the striking member 1 elastically deforms. Thus, the amount of deformation of the striking member 1 in the left-right direction is proportional to the force applied to the striking member 1 during the user's swing. In other words, the value of the first signal Sig1 indirectly indicates the force applied when the user swung the striking member 1. This makes it possible to estimate the time when the user starts swinging the striking member 1 from the value of the first signal Sig1. For example, immediately after the start of the user's swing, the amount of deformation of the striking member 1 is small. Thus, the value of the first signal Sig1 detected by the sensor 10 before and after the start of the swing is low. In other words, it can be inferred that the period when the first signal Sig1 is low includes the time at which the user starts the swing. In the following, the time at which the user starts swinging the striking member 1 is referred to as a swing start time SwT.

Similarly, it is possible to estimate the time at which the striking member 1 impacts the to-be-struck object from the value of the first signal Sig1. For example, at the moment at which the user strikes the to-be-struck object using the striking member 1, the amount of deformation of the striking member 1 is large. Thus, the value of the first signal Sig1 detected by the sensor 10 is high. In other words, it can be inferred that the time at which the striking member 1 impacts the to-be-struck object is included in the period when the value of the first signal Sig1 detected by the sensor 10 is high. In the following, the time at which the striking member 1 strikes the to-be-struck object is referred to as an impact time InT.

In the following, the structure of the sensor 10 will be described. The sensor 10 is a piezoelectric sensor that detects pressure. The sensor 10, as illustrated in FIG. 3, includes a piezoelectric film 100, the first electrode 101F, the second electrode 101B, a charge amplifier 102, and a voltage amplification circuit 103. The piezoelectric film 100 has a sheet shape. Thus, the piezoelectric film 100, as illustrated in FIG. 3, has a first main surface F1 and a second main surface F2. The length of the piezoelectric film 100 in the up-down direction is longer than that of the piezoelectric film 100 in the left-right direction. In the present embodiment, the piezoelectric film 100 has a rectangular shape with long sides extending in the up-down direction when viewed in the front-back direction. The piezoelectric film 100 generates an electric charge corresponding to the amount of deformation of the piezoelectric film 100. In the present embodiment, the piezoelectric film 100 is a polylactic acid (PLA) film. In the following, the piezoelectric film 100 is described in more detail.

The piezoelectric film 100 has a characteristic that the polarity of the electric charge generated when the piezoelectric film 100 is deformed to be stretched in the up-down direction is opposite to the polarity of the electric charge generated when the piezoelectric film 100 is deformed to be stretched in the left-right direction. Specifically, the piezoelectric film 100 is a film formed from chiral polymer. Chiral polymers are, for example, polylactic acid (PLA), especially L-type polylactic acid (PLLA). PLLA, which is composed of chiral polymer, has a helical structure in its main chain. PLLA has piezoelectricity in which the molecules are oriented by uniaxial stretching. The piezoelectric film 100 has a piezoelectric constant of d14. The uniaxial stretching direction (orientation direction) of the piezoelectric film 100 forms an angle of 45 degrees to each of the up-down and left-right directions. This 45 degrees includes, for example, angles of about 45 degrees±10 degrees. This causes the piezoelectric film 100 to deform in such a way that the piezoelectric film 100 is stretched in the up-down direction or in the up-down direction, thereby generating an electric charge. The piezoelectric film 100 generates a positive charge, for example, when the piezoelectric film 100 is deformed so as to be stretched in the up-down direction. The piezoelectric film 100 generates a negative charge, for example, when the piezoelectric film 100 is deformed so as to be stretched in the left-right direction. The magnitude of the electric charge depends on the amount of deformation of the piezoelectric film 100 due to stretching or compression. The magnitude of the electric charge is proportional to a derivative value of the amount of deformation of the piezoelectric film 100 due to stretching or compression.

The first electrode 101F is a signal electrode. The first electrode 101F is provided on the first main surface F1. The first electrode 101F covers the first main surface F1. The first electrode 101F is, for example, an organic electrode using such as indium tin oxide (ITO) or zinc oxide (ZnO), a metal film formed by vapor deposition or plating, or a printed electrode film using silver paste.

The second electrode 101B is a ground electrode. The second electrode 101B is connected to the ground potential. The second electrode 101B is provided on the second main surface F2. As a result, the piezoelectric film 100 is positioned between the first electrode 101F and the second electrode 101B. The second electrode 101B covers the second main surface F2. The second electrode 101B is, for example, an organic electrode using such as indium tin oxide (ITO) or zinc oxide (ZnO), a metal film formed by vapor deposition or plating, or a printed electrode film using silver paste.

The sensor 10 as described above is fixed to the striking member 1 with an adhesive layer, which is not illustrated, interposed therebetween. Specifically, the adhesive layer fixes the striking member 1 and the first electrode 101F. This causes, for example, the striking member 1 to stretch and contract in the up-down direction when the striking member 1 bends in the left-right direction. Thus, the piezoelectric film 100 stretches and contracts in the up-down direction. As a result, the piezoelectric film 100 generates electric charge. That is, in the present embodiment, in a case where the striking member 1 is bent toward the right, the piezoelectric film 100 generates a negative charge. In the present embodiment, in a case where the striking member 1 is bent toward the left, the piezoelectric film 100 generates a positive charge.

The charge amplifier 102 converts the electric charge generated by the piezoelectric film 100 into the first signal Sig1, which is a voltage signal. For example, the charge amplifier 102 converts the electric charge into a voltage value in the range of 0.0 V to 3.0 V. After the conversion, the charge amplifier 102 outputs the first signal Sig1 to the voltage amplification circuit 103. The voltage amplification circuit 103 amplifies the first signal Sig1 and outputs the resulting signal to the AD converter 20.

The AD converter 20 converts the first signal Sig1 from analog to digital. As a result, the AD converter 20 converts the first signal Sig1 into a digital signal. Specifically, the AD converter 20 converts the first signal Sig1 in accordance with the resolution of the AD converter 20. For example, in a case where the resolution of the AD converter 20 is 12 bits, the AD converter 20 converts the first signal Sig1 into 4096 levels of binary values as illustrated in FIG. 4. In the following, the first signal Sig1 that is converted into a digital signal is referred to as a first signal DSig1. Moreover, the AD converter 20 acquires a reference voltage. The AD converter 20 sets a reference value SiV of the first signal DSig1 on the basis of the reference voltage. For example, as illustrated in FIG. 4, the AD converter 20 sets a binary value of the reference value SiV to 2048. The AD converter 20 then outputs the first signal DSig1 to the processing device 30.

The processing device 30 determines the swing start time SwT of the striking member 1 swung by the user, on the basis of the first signal DSig1. Specifically, the processing device 30 includes the operation circuit 300 and a storage device 301 as illustrated in FIG. 2. The storage device 301 stores a program for performing processing for determining the swing start time SwT. The storage device 301 includes, for example, a read-only memory (ROM) and a random access memory (RAM). The operation circuit 300 reads out the program stored in the ROM and loads the program into the RAM. This causes the operation circuit 300 to perform processing for determining the swing start time SwT. The operation circuit 300 as described above is, for example, a central processing unit (CPU).

In the following, details of processing regarding identification of the swing start time SwT in the processing device 30 will be described. This processing is started by the processing device 30 acquiring the first signal DSig1 from the sensor 10. Specifically, first, the operation circuit 300 acquires the first signal DSig1 from the sensor 10 (FIG. 5: Step S10).

Next, the operation circuit 300 determines whether there are one or more times at which the absolute value of the difference between the reference value SiV and the first signal DSig1 becomes greater than or equal to a first determination value 1stTh (FIG. 5: Step S11). First, the operation circuit 300 calculates the absolute value of the difference between the reference value SiV and the first signal DSig1. In the following, a case where the value of the first signal DSig1 is “3” and where the reference value SiV is “2048” will be described as an example. In this case, the value obtained by subtracting the reference value SiV from the value of the first signal DSig1 is “−2045”. Thus, the operation circuit 300 calculates the absolute value of the difference as “2045”. In the following, the absolute value of the difference between the reference value SiV and the value of the first signal DSig1 is defined as a first difference value DV1.

Next, the operation circuit 300 determines whether the first difference value DV1 is greater than or equal to the first determination value 1stTh. The first determination value 1stTh is a value stored in the processing device 30. In the following, description will be made using FIG. 4 as an example. In FIG. 4, a time TT is present at which the first signal DSig1 is less than or equal to “3”. In this case, the reference value SiV is “2048”. The first difference value DV1 is thus “2045”. In contrast, in FIG. 4, the first determination value 1stTh is “2045”. Thus, the first difference value DV1 is greater than or equal to the first determination value 1stTh at the time TT. As a result, the operation circuit 300 determines that the time TT is a time at which the absolute value of the difference between the reference value SiV and the first signal DSig1 becomes greater than or equal to the first determination value 1stTh. In the following, the time at which the first difference value DV1 becomes greater than or equal to the first determination value 1stTh is referred to as a first time.

In a case where the operation circuit 300 determines that there are no times at which the first difference value DV1 becomes greater than or equal to the first determination value 1stTh (FIG. 5: No in Step S11), the processing device 30 causes the process to return to before Step S10.

In a case where the operation circuit 300 determines that there are one or more times at which the first difference value DV1 becomes greater than or equal to the first determination value 1stTh (FIG. 5: Yes in Step S11), the operation circuit 300 executes a first determination step in which the time at which the first difference value DV1 is the largest among the one or more times at which the first difference value DV1 becomes greater than or equal to the first determination value 1stTh is determined to be the impact time InT (FIG. 5: Step S12). In FIG. 4, the operation circuit 300 determines that the time TT is the first time. The operation circuit 300 does not determine any time other than the time TT to be the first time. Thus, the time at which the first difference value DV1 is the largest among the one or more times is the time TT. As a result, the operation circuit 300 determines the time TT to be the impact time InT.

Next, the operation circuit 300 identifies the swing start time SwT by examining the first signal DSig1 acquired in a time period BeTime before the impact time InT. Specifically, the operation circuit 300 executes a first identification step in which, in the first signal DSig1 acquired in the time period BeTime before the impact time InT, a most recent period MPE closest to the impact time InT is identified from among one or more periods PE where the first difference value Dv1 is less than a second determination value 2ndTh for a reference time period (Step S13 of FIG. 5). In the following, the first identification step will be described in detail.

As illustrated in FIG. 4, the operation circuit 300 identifies one or more periods PE where the first difference value DV1 is less than the second determination value 2ndTh for the reference time period in the time period BeTime before the impact time InT. The value of the second determination value 2ndTh is lower than the value of the first determination value 1stTh. For example, as illustrated in FIG. 4, the processing device 30 stores the second determination value 2ndTh as “200”. In this case, when the first difference value DV1 is less than or equal to “200”, the operation circuit 300 determines that the first difference value DV1 is less than the second determination value 2ndTh. The reference time period is set to, for example, 0.2 seconds, 0.3 seconds, or the like. For example, in a case where the reference time period is set to “0.2 seconds” in the processing device 30, the operation circuit 300 identifies a period where the first difference value DV1 is less than the second determination value 2ndTh for 0.2 seconds to be a period PE. The operation circuit 300 identifies one or more periods PE. Specifically, after identifying the first period PE, the operation circuit 300 identifies whether a period PE is present after the first period PE, which has been identified. For example, as illustrated in FIG. 4, the operation circuit 300 identifies a period PE1 as a period PE. In the example illustrated in FIG. 4, a period PE is present after the period PE′. In this case, the operation circuit 300 identifies the period PE present after the period PE1 to be a period PE2.

Next, the operation circuit 300 identifies the most recent period MPE closest to the impact time InT from among the one or more periods PE. For example, in the example illustrated in FIG. 4, the operation circuit 300 has identified the periods PE1 and PE2. As illustrated in FIG. 4, the period PE2 is closer to the impact time InT than the period PE1 is. Thus, the operation circuit 300 identifies the period PE2 to be the most recent period MPE.

Lastly, the operation circuit 300 executes a second identification step in which the swing start time SwT is identified on the basis of the most recent period MPE (Step S14 of FIG. 5). For example, the operation circuit 300 identifies the earliest time to the latest time of the most recent period MPE to be the swing start time SwT. Specifically, in a case where the earliest time of the most recent period MPE is 5.0 seconds and the latest time of the most recent period MPE is 5.2 seconds, the operation circuit 300 identifies the swing start time SwT to be between 5.0 and 5.2 seconds.

Through the processing described above, the processing device 30 identifies the swing start time SwT. The operation circuit 300 repeats the processing from Step S10 to Step S14.

The following describes a method for verifying whether or not the processing described above has been performed by the processing unit 30. In verification, in a case where each of the first determination value 1stTh, the second determination value 2ndTh, and the reference time period is identified, the processing described above can be considered to have been performed. In the following, a method for identifying the first determination value 1stTh, the second determination value 2ndTh, and the reference time period will be described in detail. First, the processing device 30 receives a second signal that mimics the first signal DSig1. The second signal has an impact period and a preparatory operation period. The impact period is a period located later in time than the preparatory operation period.

At first, a method for identifying the first determination value 1stTh will be described. First, the reference value SiV is set to the value of the second signal in the preparatory operation period. Specifically, as in the example illustrated in FIG. 4, the value of the second signal is set to, for example, “2048”, which is the reference value SiV. Next, the value of the second signal is gradually increased in the impact period. When the value of the second signal becomes greater than or equal to a predetermined value, the processing device 30 identifies the swing start time SwT. Specifically, in a case where the value of the second signal is increased in the impact period, the first difference value DV1 becomes greater than or equal to the first determination value 1stTh. In this case, the value of the second signal is the reference value SiV in the preparatory operation period. That is, the value of the second signal is less than or equal to the second determination value 2ndTh for the reference time period in the preparatory operation period. Thus, the condition for the processing device 30 to execute the first identification step and the second identification step is met. As a result, the processing device 30 identifies the swing start time SwT. That is, the first determination value 1stTh is identified by identifying the value of the second signal when the processing device 30 identifies the swing start time SwT.

Next, a method for identifying the second determination value 2ndTh will be described. The second determination value 2ndTh is identified after the first determination value 1stTh is identified. Specifically, after the first determination value 1stTh is identified, the value of the second signal is gradually increased in the preparatory operation period. When the value of the second signal becomes greater than or equal to a predetermined value, the processing device 30 will no longer identify the swing start time SwT. Specifically, in a case where the value of the second signal is decreased in the preparatory operation period, the first difference value DV1 becomes greater than or equal to the second determination value 2ndTh. Thus, the condition for the processing device 30 to execute the first identification step is no longer met. As a result, the processing device 30 will no longer identify the swing start time SwT. That is, the second determination value 2ndTh is identified by identifying the value of the second signal when the processing device 30 no longer identifies the swing start time SwT.

Lastly, a method for identifying the reference time period will be described. The reference time period is identified after the second determination value 2ndTh is identified. Specifically, in a state where the value of the second signal is made lower than the second determination value 2ndTh in the preparatory operation period, the time during which the second signal is outputted is gradually shortened in the preparatory operation period. In the following, the time during which the second signal is outputted in the preparatory operation period is referred to as a second time. In a case where the length of the second time becomes less than or equal to a predetermined length, the processing device 30 will no longer identify the swing start time SwT. Specifically, in a case where the second time is shortened, the second time becomes shorter than the reference time period. In this case, the condition that the first difference value DV1 is less than or equal to the second determination value 2ndTh for the reference time period is no longer met. That is, the condition for the processing device 30 to execute the first identification step is no longer met. As a result, the processing device 30 will no longer identify the swing start time SwT. That is, the reference time period is identified by identifying the length of the second time when the processing device 30 no longer identifies the swing start time SwT.

By using the method described above, the first determination value 1stTh, the second determination value 2ndTh, and the reference time period can be identified. In a case where the first determination value 1stTh, the second determination value 2ndTh, and the reference time period are identified, the processing illustrated in the present embodiment can be considered to have been performed.

(Effects of First Embodiment)

With the processing device 30, the moment at which the user starts swinging the striking member 1 can be detected with high accuracy. Specifically, the processing device 30 includes the operation circuit 300. The operation circuit 300 determines the start of the swing on the basis of the first signal Sig1 acquired from the sensor 10 that detects deformation of the striking member 1 during the swing. In more detail, the operation circuit 300 executes the first determination step in which the time at which the value of the first signal DSig1 becomes greater than or equal to the first determination value 1stTh is determined to be the impact time InT. Next, the operation circuit 300 executes the first identification step in which, in the first signal DSig1 acquired in the time period BeTime before the impact time InT, the most recent period MPE closest to the impact time InT is identified from among one or more periods PE where the value of the first signal DSig1 is less than the second determination value 2ndTh for the reference time period. Lastly, the operation circuit 300 executes the second identification step in which the swing start time SwT is identified on the basis of the most recent period MPE. In the following, description will be made by comparing a processing device that identifies the time at which an acquired signal exceeds a determination value to be a swing start time (hereinafter the processing device will be referred to as a first comparative example) with the processing device 30.

In the first comparative example, the determination value is set on the basis of the magnitude of a signal generated at the start of the swing. As a result, the time at which the value of the signal obtained from the sensor exceeds the determination value is detected as a swing start time. However, there is a possibility that the user may impact on the striking member through a movement other than swinging. For example, the user accidentally knocks down the striking member, and this movement impacts on the striking member. In this case, a force equivalent to the force generated by the swing may be applied to the striking member. In this case, the first comparative example may erroneously determine the movement other than swinging to be the start of the swing. Thus, the first comparative example cannot detect with high accuracy the moment at which the user starts swinging the striking member.

In contrast, after identifying the impact time InT, the processing device 30 identifies the swing start time SwT. The time when the greatest force is applied to the striking member 1 is the moment of impact. Thus, in a case where the first determination value 1stTh is set in accordance with the magnitude of the impact, the impact time InT is less likely to be erroneously determined. After determining the impact time InT, the processing device 30 identifies the swing start time SwT. Thus, even in a case where a force is applied to the striking member 1 through a movement other than swinging, the processing device 30 is less likely to erroneously determine a swing movement. Thus, the processing device 30 can detect with high accuracy the moment at which the user starts swinging the striking member 1.

With the processing device 30, the processing device 30 can detect with high accuracy the moment at which the user starts swinging the striking member 1. In more detail, the operation circuit 300 executes the first identification step in which, in the first signal DSig1 acquired in the time period BeTime before the impact time InT, the most recent period MPE closest to the impact time InT is identified from among one or more periods PE where the first difference value DV1 is less than the second determination value 2ndTh for the reference time period. The operation circuit 300 also executes the second identification step in which the swing start time SwT is identified on the basis of the most recent period MPE. The swing start time SwT is located before the impact time InT. At the swing start time SwT, significant force is not applied to the striking member 1. Thus, the swing start time SwT can be identified by identifying the period in which the first difference value DV1 is low in a time period before the impact time InT. Note that, in this case, the operation circuit 300 may identify one or more periods PE in the time period before the impact time InT. In this case, the periods PE before the swing start time SwT are periods in which the first difference value DV1 is low because the striking member 1 is stationary. That is, periods PE far from the impact time InT are less likely to be the swing start time SwT. Thus, the operation circuit 300 performs processing for identifying the most recent period MPE, which is closest to the impact time InT. Consequently, the periods PE far from the impact time InT are not determined to be the swing start time SwT. Thus, the possibility that the operation circuit 300 erroneously determines the swing start time SwT is reduced. As a result, the processing device 30 can detect with high accuracy the moment at which the user starts swinging the striking member 1.

With the processing device 30, the moment at which the user starts swinging the striking member 1 can be detected with high accuracy. The processing device 30 identifies the swing start time SwT in accordance with deformation of the striking member 1. That is, in a case where the striking member 1 is easily deformed, the processing device 30 can easily identify the swing start time SwT. A golf club is a striking member 1 that is easily deformed when being swung. That is, when the striking member 1 is a golf club, the processing device 30 can detect with especially high accuracy the moment at which the user starts swinging the striking member 1.

(First Modification of First Embodiment)

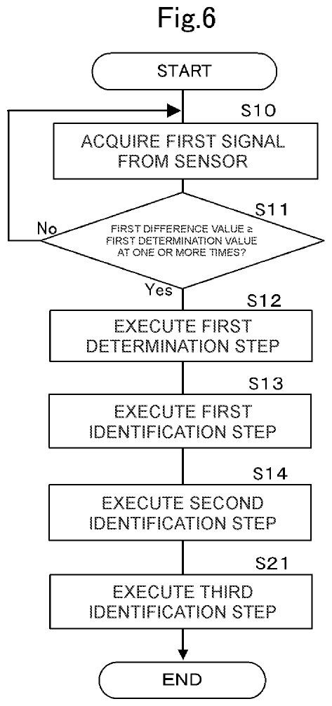

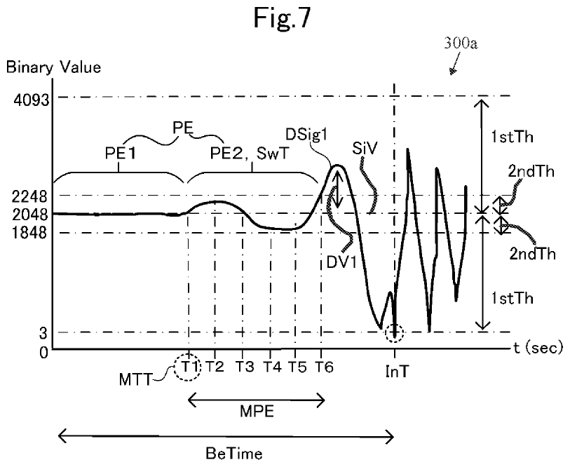

In the following, a processing device 30a according to a first modification of the first embodiment will be described with reference to the drawings. FIG. 6 is a flowchart illustrating processing performed by the processing device 30a. FIG. 7 is a diagram illustrating an example of a third identification step executed by an operation circuit 300a.

The processing device 30a differs from the processing device 30 in that the processing device 30a executes the third identification step after the second identification step. Specifically, the processing device 30a includes the operation circuit 300a. After executing the second identification step (FIG. 6: after Step S14), the operation circuit 300a further executes the third identification step (FIG. 6: Step S21). The third identification step is a step in which a time MTT farthest from the impact time InT in the most recent period MPE closest to the impact time InT is identified to be the swing start time SwT.

For example, as illustrated in FIG. 7, suppose that the operation circuit 300a acquires the value of the first signal DSig1 at each of times T1 to T6 in the most recent period MPE. In FIG. 7, the operation circuit 300a acquires the value of the first signal DSig1 at the times T1, T2, T3, T4, T5, and T6 in this order. In this case, the time T1 is the farthest from the impact time InT among the times T1 to T6. In other words, the time T1 is the farthest from the impact time InT in the most recent period MPE. In this case, the operation circuit 300a identifies the time T1 to be the swing start time SwT. A program for executing the third identification step is stored in a storage device 301a (not illustrated) of the processing device 30a.

(Effects of First Modification of First Embodiment)

With the processing device 30a, the moment at which the user starts swinging the striking member 1 can be detected with higher accuracy. In more detail, the operation circuit 300a further executes the third identification step in which the time MTT farthest from the impact time InT in the most recent period MPE closest to the impact time InT is identified to be the swing start time SwT. This allows the swing start time SwT to be narrowed down to a single time. Thus, the moment at which the user starts swinging the striking member 1 can be detected with higher accuracy.

With the processing device 30a, the user's swing can be accurately analyzed. In more detail, the operation circuit 300a further executes the third identification step in which the time MTT farthest from the impact time InT in the most recent period MPE closest to the impact time InT is identified to be the swing start time SwT. This allows the time from the swing start time SwT to the impact time InT to be identified with high accuracy. Thus, the first signal DSig1 generated during the period from when the user starts the swing to when the user strikes the to-be-struck object can be accurately identified. As a result, the operation circuit 300a can accurately analyze the user's swing by using the accurately identified first signal DSig1 to analyze the user's swing.

(Second Modification of First Embodiment)

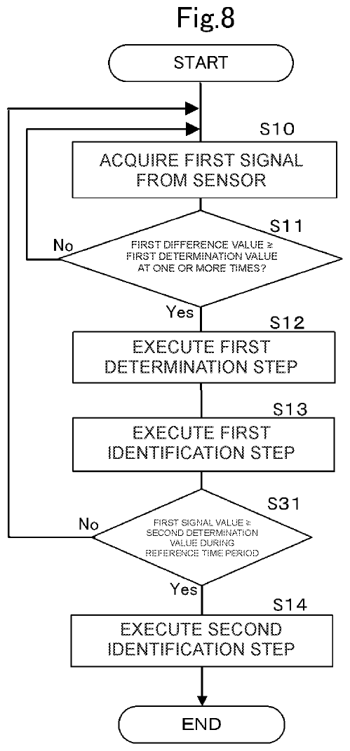

In the following, a processing device 30b according to a second modification of the first embodiment will be described with reference to the drawings. FIG. 8 is a flowchart illustrating processing performed by the processing device 30b.

The processing device 30b differs from the processing device 30 in that processing is added between the first determination step and the second identification step. Specifically, the processing device 30b includes an operation circuit 300b, which is not illustrated. The operation circuit 300b does not identify the most recent period MPE closest to the impact time InT in a case where the value of the first signal DSig1 acquired in the time period BeTime before the impact time InT is not less than the second determination value 2ndTh for the reference time period.

Specifically, after executing the first identification step (FIG. 8: after Step S13), the operation circuit 300b determines whether the value of the first signal DSig1 is higher than the second determination value 2ndTh for the reference time period (FIG. 8: Step S31). In a case where the value of the first signal DSig1 is less than the second determination value 2ndTh for the reference time period (FIG. 8: Yes in Step S31), the operation circuit 300b executes the second identification step (FIG. 8: Step S14). In a case where the value of the first signal DSig1 is not less than the second determination value 2ndTh for the reference time period (FIG. 8: No in Step S31), the operation circuit 300b causes the process to return to before Step S10.

(Effects of Second Modification)

According to the processing device 30b, the processing device 30b can improve its processing speed. In more detail, the operation circuit 300b does not identify the most recent period MPE closest to the impact time InT in a case where the value of the first signal DSig1 acquired in the time period BeTime before the impact time InT is not less than the second determination value 2ndTh for the reference time period. In a case where the value of the first signal DSig1 is not less than the second determination value 2ndTh for the reference time period, there is a possibility that the processing device 30b has erroneously detected the impact time InT. In this case, the processing device 30b does not execute the second identification step. Thus, the processing device 30b can promptly terminate the process caused by the erroneous detection. That is, the processing speed of the processing device 30b is improved.

### Second Embodiment

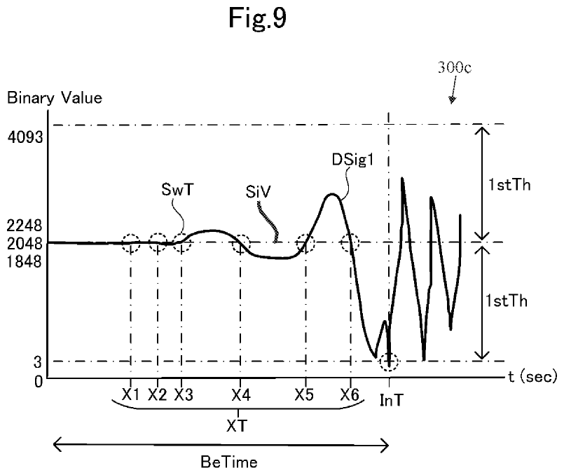

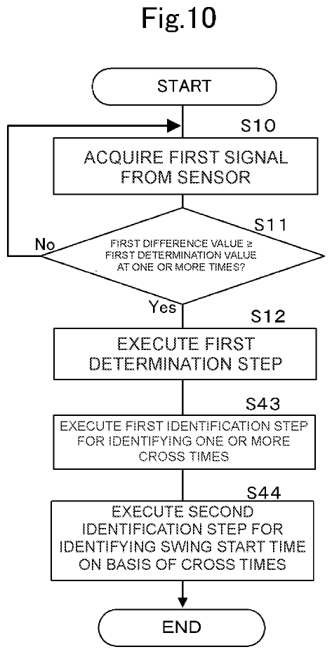

In the following, a processing device 30c according to a second embodiment will be described with reference to the drawings. FIG. 9 is a graph illustrating an example of the swing start time SwT identified through processing performed by an operation circuit 300c. In FIG. 9, the vertical axis represents signal output. In FIG. 9, the horizontal axis represents time. FIG. 10 is a flowchart illustrating processing performed by the processing device 30c.

The processing device 30c differs from the processing device 30 in that the processing device 30c uses a different method to identify the swing start time SwT. Specifically, the processing device 30c includes the operation circuit 300c. The operation circuit 300c identifies the swing start time SwT using a method different from that used by the operation circuit 300. In the following, the same configurations of the processing device 30c as those of the processing device 30 are denoted by the same signs, and description will be omitted.

The operation circuit 300c identifies the swing start time SwT by identifying the time at which the first signal DSig1 intersects the reference value SiV. The intersection of the first signal DSig1 with the reference value SiV means, specifically, that the value of the first signal DSig1 changes from above the reference value SiV to below the reference value SiV, or that the value of the first signal DSig1 changes from below the reference value SiV to above the reference value SiV. In the following, the time at which the value of the first signal DSig1 changes from above the reference value SiV to below the reference value SiV and the time at which the value of the first signal DSig1 changes from below the reference value SiV to above the reference value SiV are each defined as a cross time XT.

In the following, processing performed by the operation circuit 300c will be described in detail. After the first determination step (after Step S12 of FIG. 10), the operation circuit 300c executes a first identification step in which one or more cross times XT are identified in the first signal DSig1 acquired in the period BeTime before the impact time InT (Step S43 of FIG. 10). In the case of the example illustrated in FIG. 9, the first signal DSig1 intersects the reference value SiV at times X1 to X6. In this case, the operation circuit 300c identifies the times X1 to X6 to be cross times XT. The times X6 to X1 are close to the impact time InT in this order.

Next, the operation circuit 300c executes a second identification step in which the swing start time SwT is identified on the basis of the cross time XT that is the n-th closest to the impact time InT among the one or more cross times XT, where n is a reference number. In the following, a case that is illustrated in FIG. 9 and in which the reference number is set to four in the processing device 30c will be described as an example. In this case, as illustrated in FIG. 9, the cross time XT that is the fourth closest to the impact time InT among the cross times XT is the time X3. Thus, the operation circuit 300c identifies the time X3 to be the swing start time SwT.

The operation circuit 300c repeats processing in Steps S10 to S12, S43, and S44 as illustrated in FIG. 10.

(Effects of Second Embodiment)

With the processing device 30c, the moment at which the user starts swinging the striking member 1 can be detected with high accuracy. Specifically, the processing device 30c includes the operation circuit 300c. The operation circuit 300c determines the start of the swing on the basis of the first signal DSig1 acquired from the sensor 10 that detects deformation of the striking member 1 during the swing. In more detail, the operation circuit 300c executes the first determination step in which the impact time InT is determined when the value of the first signal DSig1 becomes greater than or equal to the first determination value 1stTh. The operation circuit 300c executes the first identification step in which one or more cross times XT are identified in the first signal DSig1 acquired in the period BeTime before the impact time InT. The operation circuit 300c executes the second identification step in which the swing start time SwT is identified on the basis of the cross time XT that is the n-th closest to the impact time InT among the one or more cross times XT, where n is the reference number. In this case, after identifying the impact time InT, the processing device 30c identifies the swing start time SwT. The time when the greatest force is applied to the striking member 1 is the moment of impact. Thus, in a case where the first determination value 1stTh is set in accordance with the magnitude of the impact, the impact time InT is less likely to be erroneously determined. After determining the impact time InT, the processing device 30c identifies the swing start time SwT. Thus, even in a case where a force is applied to the striking member 1 through a movement other than swinging, the processing device 30c is less likely to erroneously determine a swing movement. Thus, the processing device 30c can detect with high accuracy the moment at which the user starts swinging the striking member 1.

With the processing device 30c, the moment at which the user starts swinging the striking member 1 can be easily detected. Specifically, the processing device 30c includes the operation circuit 300c. The operation circuit 300c determines the start of the swing on the basis of the first signal DSig1 acquired from the sensor 10 that detects deformation of the striking member 1 during the swing. In more detail, the operation circuit 300c executes the first identification step in which one or more cross times XT are identified in the first signal DSig1 acquired in the period BeTime before the impact time InT. The operation circuit 300c executes the second identification step in which the swing start time SwT is identified on the basis of the cross time XT that is the n-th closest to the impact time InT among the one or more cross times XT, where n is the reference number. For example, in the processing device 30c, the reference number is set as follows. The reference number is set to the number of cross times XT that occur between the time at which the user starts the swing and the time at which the to-be-struck object is struck. In this case, the swing start time SwT can be easily identified by calculating backward, from the impact time InT, the cross time XT that is the n-th closest to the impact time InT. Thus, the processing device 30c can easily detect the moment at which the user starts swinging the striking member 1.

(Third Modification of First or Second Embodiment)

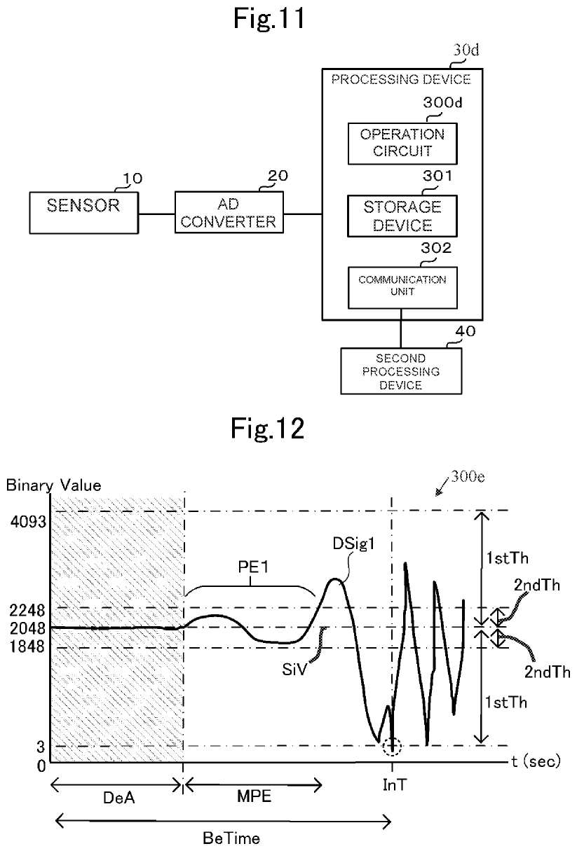

In the following, a processing device 30d according to a third modification of the first or second embodiment will be described with reference to the drawings. FIG. 11 is a diagram illustrating an example of communication between the processing device 30d and a second processing device 40.

As illustrated in FIG. 11, the processing device 30d differs from the processing devices 30 and 30b in that the processing device 30d includes a communication unit 302 (e.g., a transmitter). The communication unit 302 transmits, as illustrated in FIG. 11, the swing start time SwT to the second processing device 40 different from the processing device 30d. The second processing device 40 is, for example, a swing analyzer. The swing analyzer analyzes, for example, the user's swing on the basis of the first signal DSig1. In the third modification, the processing device 30d is attached to the striking member 1. The second processing device 40 is not attached to the striking member 1. That is, the communication unit 302 performs communication between the processing device 30d, which is attached to the striking member 1, and the second processing device 40, which is not attached to the striking member 1. The communication unit 302 performs, for example, wireless communication. Wireless communication is, for example, communication using Bluetooth® or the like.

(Effects of Third Modification)

According to the processing device 30d, the processing device 30d can accurately analyze the user's swing. In more detail, the processing device 30d includes the communication unit 302. The processing device 30d is attached to the striking member 1. The communication unit 302 transmits the swing start time SwT to the second processing device 40 different from the processing device 30d. In this case, the second processing device 40 can acquire the accurately identified swing start time SwT and impact time InT. The second processing device 40 can estimate that the first signal DSig1 located between the swing start time SwT and the impact time InT is the first signal DSig1 generated during the user's swing. In other words, the possibility of the second processor 40 analyzing the user's swing on the basis of the first signal DSig1 generated by a movement other than the swing movement is reduced. As a result, the processing device 30d allows the second processing device 40 to accurately analyze the user's swing.

(Fourth Modification of First or Second Embodiment)

In the following, a processing device 30e according to a fourth modification of the first or second embodiment will be described with reference to the drawings. FIG. 12 is a diagram illustrating an example of a deletion step executed by the processing device 30e. In FIG. 12, the dot pattern indicates a period in which the first signal DSig1 is deleted.

The processing device 30e differs from the processing devices 30 and 30b in that the processing device 30e deletes an unnecessary signal in the acquired first signal DSig1. Specifically, the processing device 30e executes the deletion step in which the first signal DSig1 acquired in the time period before the swing start time SwT is deleted. A storage device 301e (not illustrated) of the processing device 30e stores a program for executing the deletion step.

For example, as illustrated in FIG. 12, the processing device 30e identifies the most recent period MPE including the swing start time SwT. In this case, the first signal DSig1 acquired in the time period before the swing start time SwT is acquired in the time period before the most recent period MPE. Thus, the processing device 30e deletes, as illustrated in FIG. 12, the first signal DSig1 acquired in a period DeA before the most recent period MPE.

(Effects of Fourth Modification)

According to the processing device 30e, the processing speed of the processing device 30e is improved. Specifically, the processing device 30e executes the deletion step in which the first signal DSig1 acquired in the time period before the swing start time SwT is deleted. In this case, the first signal DSig1 is deleted except for the signal needed to analyze the user's swing. In the following, a case where the processing device 30e transmits the first signal DSig1 to the swing analyzer will be described as an example. In this case, the processing device 30e converts the first signal DSig1 into data that can be transmitted to the swing analyzer. In this case, the size of data to be transmitted to the swing analyzer can be reduced by executing the deletion step. Thus, the time for the processing device 30e to complete transmission of data to the swing analyzer can be reduced. That is, the processing speed of the processing device 30e is improved.

### Other Embodiments

The processing devices 30 to 30e according to the present disclosure are not limited to the processing devices 30 to 30e but can be modified within the scope of the gist of the present disclosure. Note that the configurations of the processing devices 30 to 30e may be freely combined.

Note that the processing devices 30 to 30c and 30e may not necessarily be attached to the striking member 1. For example, the striking member 1 is equipped with a communication unit for striking members. The communication unit for striking members may transmit the first signal DSig1 acquired from the sensor 10 to the processing devices 30 to 30c and 30e. In this case, the processing devices 30 to 30c and 30e may be, for example, servers, smart phones, or other terminals. In a case where the processing devices 30 to 30c and 30e are, for example, servers, smart phones, or the like, the servers, smart phones, or the like execute the first determination step, the first identification step, and the second identification step.

Note that the striking member 1 may not necessarily be a golf club. The striking member 1 may be a stick-shaped member such as a bat for baseball or a racket for tennis, badminton, and so forth. In other words, the striking member 1 may include at least one out of a golf club, a bat, and a racket. As with a golf club, a bat and a racket are also striking members 1, which are easily deformed by being swung. That is, in a case where the striking member 1 is a bat or a racket, the processing device 30 can detect with particularly high accuracy the moment at which the user starts swinging the striking member 1.

Note that the processing devices 30 to 30e determine the impact time InT on the basis of the first difference value DV1 in the first determination step. The first difference value DV1 is the absolute value of the difference between the value of the first signal DSig1 and the reference value SiV. That is, the processing devices 30 to 30e can determine the swing start time SwT even in a case where the waveform of the first signal DSig1 is inverted with respect to the reference value SiV. Thus, the processing devices 30 to 30e can determine the swing start time SwT even in a case where the user flips the striking member 1 for each swing. For example, in a case where the striking member 1 is a bat, a racket, or the like, the user may flip the striking member 1 for each swing. Even in this case, the processing devices 30 to 30e can detect with high accuracy the swing start time SwT for each swing. Similarly, the processing devices 30 to 30e can determine with high accuracy the swing start time SwT even in a case where the user changes the swing direction of the striking member 1 for each swing.

Note that, in the first embodiment, the processing device 30 identifies one or more periods PE where the first difference value DV1 is less than the second determination value 2ndTh for the reference time period. However, the processing device 30 may identify periods PE using a reference sampling number instead of the reference time period. In this case, the operation circuit 300 identifies the consecutive number of times that the first difference value DV1 is less than the second determination value 2ndTh in the first identification step. The operation circuit 300 identifies a period in which the consecutive number of times that the first difference value DV1 is less than the second determination value 2ndTh exceeds the reference sampling number to be a period PE. The reference sampling number is set in the processing device 30. The reference sampling number is set, for example, to five or six in the processing device 30. For example, in a case where the sampling number is set to five in the processing device 30, the processing device 30 identifies a period in which the first difference value DV1 is less than the second determination value 2ndTh five consecutive times to be a period PE.

Note that the striking member 1 is a golf club in the first embodiment or the second embodiment. Thus, the to-be-struck object is, for example, a golf ball in the first embodiment or the second embodiment.

Note that the communication unit 302 may perform wired communication.

Note that the processing device 30d may not necessarily execute the deletion step on the basis of the most recent period MPE. For example, in a case where the processing device 30d executes the third identification step, the processing device 30d may delete the first signal DSig1 acquired in a time period before the swing start time SwT identified in the third identification step.

Note that the processing devices 30 to 30e may not necessarily receive the signal converted from analog to digital by the AD converter 20. For example, the processing devices 30 to 30e may perform the AD conversion processing. In this case, the processing devices 30 to 30e receive an analog signal from the sensor 10. The processing devices 30 to 30e convert the analog signal to digital. The processing devices 30 to 30e identify the impact time InT and the swing start time SwT on the basis of the first signal DSig1 obtained as a result of the AD conversion.

Note that the deformation direction of the striking member 1 is not limited only to the up-down direction. For example, when viewed in the up-down direction, the striking member 1 may deform in the direction of rotation about the center of the striking member 1. That is, the striking member 1 may be twisted in the direction of rotation. In this case, the sensor 10 may detect torsion in the direction of rotation.

Note that the value of the first signal DSig1 may not necessarily be the derivative of the amount of deformation of the striking member 1. The value of the first signal DSig1 may be the amount of deformation of the striking member 1. In this case, the sensor 10 includes a strain sensor.

Note that in a case where the value of the first signal DSig1 is the amount of deformation of the striking member 1, the value of the first signal DSig1 may be the amount of deformation in a direction other than the left-right direction.

Note that the number of periods PE identified by the operation circuit 300 is not limited to two in the example illustrated in FIG. 4. The number of periods PE identified by the operation circuit 300 may be one. In this case, the one period PE is the most recent period MPE. Moreover, the number of periods PE identified by the operation circuit 300 may be three or more. In this case, the operation circuit 300 identifies the most recent period MPE closest to the impact time InT from among the three or more periods PE.

Note that the first determination value 1stTh may not necessarily be “2045”.

Note that the second determination value 2ndTh may not necessarily be “200”.

Note that the operation circuit 300 may not identify the swing start time SwT on the basis of the first signal DSig1 that is converted into a bit value. For example, the operation circuit 300 may identify the swing start time SwT on the basis of the first signal DSig1 that is converted into 0-3 V. In this case, the first determination value 1stTh and the second determination value 2ndTh are set in the range of 0-3 V.

Note that the operation circuit 300 may identify the periods PE in order of proximity from the impact time InT. For example, after identifying the first period PE, the operation circuit 300 may identify whether a period PE is present in a time period before the first identified period PE. In this case, for example, the operation circuit 300 identifies the period PE1 as a period PE. In a case where a period PE is present in the time period before the period PE1, the operation circuit 300 may identify the period PE present in the time period before the period PE1 to be a period PE2.

Note that the operation circuits 300, 300a, and 300c to 300e may not necessarily execute the third identification step.

The processing devices 30 to 30c and 30e may not necessarily be equipped with the communication unit 302.

Note that the communication unit 302 may transmit the swing start time SwT to a plurality of second processing devices 40.

Note that the communication unit 302 may not necessarily transmit the swing start time SwT to the second processing device 40.

Note that the operation circuits 300 to 300d may not necessarily execute the deletion step.

The operation circuits 300 to 300e may not necessarily be CPUs. The operation circuits 300 to 300e may be, for example, micro processing units (MPU) or the like.

Note that the storage device 301 may not necessarily include a read-only memory (ROM). The storage device 301 may include, for example, a flash memory instead of a ROM.

Note that the charge amplifier 102 may not necessarily convert an electric charge into a voltage value in the range of 0.0 V to 3.0 V. The charge amplifier 102 may convert an electric charge into a voltage value in a range other than 0.0 V to 3.0 V. The charge amplifier 102 may convert, for example, an electric charge into the range of 0.0 V to 1.5 V, 0.0 V to 5.0 V, or the like.

Note that the resolution of the AD converter 20 is not limited to the example in which the resolution is 12 bits. The resolution of the AD converter 20 may be any bit value other than 12 bits. The resolution of the AD converter 20 may be, for example, a 10 bit value or a 16 bit value.

Note that the processing devices 30 to 30e may execute the first determination step in which the impact time InT is determined on the basis of one or more times at which the first difference value DV1 becomes greater than or equal to the first determination value 1stTh. In other words, the processing devices 30 to 30e may not necessarily determine, to be the impact time InT, the time at which the first difference value DV1 is the largest among one or more times at which the first difference value DV1 becomes greater than the first determination value 1stTh in the first determination step. The processing devices 30 to 30e may determine, to be the impact time InT, the time at which the first difference value DV1 becomes greater than or equal to the first determination value 1stTh, for example. In more detail, in a case where the processing devices 30 to 30e has identified the time at which the first difference value DV1 becomes greater than or equal to the first determination value 1stTh, the processing devices 30 to 30e may determine the time at which the first difference value DV1 becomes greater than or equal to the first determination value 1stTh to be the impact time InT. Even in this case, the processing devices 30 to 30e can detect with high accuracy the moment at which the user starts swinging the striking member 1.
1: striking member
10: sensor
100: piezoelectric film
101F: first electrode
101B: second electrode
102: charge amplifier
103: voltage amplification circuit
20: AD converter
30 to 30e: processing device
300 to 300e: operation circuit
301: storage device
Sig1, DSig1: first signal
PE, PE1, PE2: period
MPE: most recent period
InT: impact time
SwT: swing start time
1stTh: first determination value
2ndTh: second determination value
DV1: first difference value
XT: cross time

1. A processing device comprising:
an operation circuit configured to determine a swing start time based on a first signal, the first signal being acquired from a sensor that is attached to a striking member for striking an object by being swung and that is configured to detect deformation of the striking member when the striking member is swung,
wherein an absolute value of a difference between a reference value and a value of the first signal is a first difference value, and
wherein the operation circuit is configured to:
determine an impact time based on one or more times at which the first difference value becomes greater than or equal to a first determination value,
identify, in the first signal acquired in a time period before the impact time, a most recent period that is closest to the impact time from among one or more periods where the first difference value is less than a second determination value for a reference time period, and
identify the swing start time based on the most recent period.

2. A processing device comprising:
an operation circuit configured to determine a swing start time based on a first signal, the first signal being acquired from a sensor that is attached to a striking member for striking an object by being swung and that is configured to detect deformation of the striking member when the striking member is swung,
wherein a time at which a value of the first signal changes from above a reference value to below the reference value and a time at which the value of the first signal changes from below the reference value to above the reference value are each a cross time,
wherein an absolute value of a difference between the reference value and the value of the first signal is a first difference value, and
wherein the operation circuit is configured to:
determine an impact time based on one or more times at which the first difference value becomes greater than or equal to a first determination value,
identify one or more of the cross times in the first signal acquired in a time period before the impact time, and
identify the swing start time based on the cross time that is an n-th closest to the impact time from among the identified one or more cross times, n being a reference number.

3. The processing device according to claim 1, wherein the operation circuit is further configured to:
identify the swing start time to be a time farthest from the impact time in the most recent period.

4. The processing device according to claim 1, wherein the operation circuit is configured to not identify the most recent period when the first difference value is not less than the second determination value for the reference time period.

5. The processing device according to claim 1, wherein the striking member is a golf club, a bat, or a racket.

6. The processing device according to claim 2, wherein the striking member is a golf club, a bat, or a racket.

7. The processing device according to claim 1, further comprising:
a transmitter,
wherein the processing device is attached to the striking member, and
wherein the transmitter is configured to transmit the swing start time to a second processing device different from the processing device.

8. The processing device according to claim 2, further comprising:
a transmitter,
wherein the processing device is attached to the striking member, and
wherein the transmitter is configured to transmit the swing start time to a second processing device different from the processing device.

9. The processing device according to claim 1, wherein the processing is further configured to:
delete the first signal acquired in the time period before the swing start time.

10. The processing device according to claim 2, wherein the processing is further configured to:
delete the first signal acquired in the time period before the swing start time.

11. The processing device according to claim 1, wherein the operation circuit is further configured to:
determine the impact time to be a time at which the first difference value is the largest among one or more times at which the first difference value becomes greater than or equal to the first determination value.

12. The processing device according to claim 2, wherein the operation circuit is further configured to:
determine the impact time to be a time at which the first difference value is the largest among one or more times at which the first difference value becomes greater than or equal to the first determination value.
